(19) United States
(12) Patent Application Publication
(10) Pub. No.: US 2014/0196365 A1
(43) Pub. Date: Jul. 17, 2014

(54) Plant Pot and Support Structure

(71) Applicant: Al Michael Washington, Flint, MI (US)

(72) Inventor: Al Michael Washington, Flint, MI (US)

(21) Appl. No.: 13/796,370

(22) Filed: Mar. 12, 2013

Related U.S. Application Data
(60) Provisional application No. 61/753,234, filed on Jan. 16, 2013.

(51) Int. Cl. A01G 9/12; A01G 9/02

(52) U.S. Cl. CPC A01G 9/124; A01G 9/02
USPC 47/66.6; 47/65.5

(57) ABSTRACT

A plant pot and support structure for supporting a plant growing in the pot including the plant pot, at least one pillar connected to the plant pot, and at least one mesh supported by and connected to the pillar. The plant grows upwardly through, and is supported by, the mesh. The pillars are connected to and supported by the plant pot. The mesh is suspended in a horizontal plane allowing the plant to grow up and through the openings in the mesh, which in turn provides support to the plant. In doing so, the plant does not need to divert its growth resources toward strengthening its stalk and can maximize its fruit or flowering yield. In another embodiment, there is disclosed a plant pot having a sidewall that includes at least one bore extending downwardly along the sidewall.

### CROSS REFERENCE TO RELATED APPLICATION

This application claims the benefit of U.S. Provisional Application 61/753,234, which was filed on Jan. 16, 2013, the disclosure of which is hereby incorporated by reference.

### BACKGROUND OF THE INVENTION

1. Field of the Invention

The present invention pertains to a support structure for a plant. More particularly, the present invention pertains to a support structure for a potted plant in which the support structure is supported by the plant's pot.

2. Description of the Prior Art

Gardeners are always trying to increase the yield of their plants using different planting techniques. It is well-known that flowering and fruiting plants produce a higher yield when given a support structure that allows the plant to divert more of its energy to producing the flowers or fruit, rather than strengthening its stalks to support itself. For instance, tomato plants and peonies are known to require substantial support to keep from falling over under their own weight. But even plants that can stand on their own still benefit from external support in order to maximize the plant's yield. This is typically accomplished by securing the plant to support stakes or placing a generally cylindrical metal frame, or cage, in the soil around the plant. As the plant grows, its branches and stalks begin to droop or lean outwardly under their own weight. The metal frame provides support to the outer stalks and keeps them from drooping over.

When plants are grown in larger volumes, it is also known that a mesh, or netting, can be horizontally suspended above a group of plants. The mesh, or netting, is supported at its ends or around its edges. The plants then grow up and through the horizontal mesh, and use the mesh for support, rather than use its resources. This allows the plant to allocate those resources to fruit or flower production that would otherwise have gone into strengthening its stalk and branches.

However, there are shortcomings in the prior art that the present invention seeks to overcome. For example, metal frames function primarily to keep the plant from drooping to the side. But these may not provide adequate support, particularly to the plant's central stalks. Support stakes are no better because it is tedious to secure the plants to the stakes, and the stakes can easily be toppled because they are simply driven into the soil.

Suspending a mesh or netting over the plants can provide the adequate support needed. However, this is only a suitable solution when there is a group of plants. Even still, once the plants have grown through the mesh and are being supported by it, the individual plants cannot be moved without either destroying the plant or the mesh.

Thus, there remains a need for a support structure for a potted plant that provides adequate support and allows each individual plant pot to be moved.

The present invention seeks to improve upon the prior art by providing a support structure for a planted pot which allows each pot to be individually moved, and which also provides adequate support to the entire plant by providing a support structure that is connected to the pot itself, rather than simply being placed in the soil along with the plant.

### SUMMARY OF THE INVENTION

The present invention provides a support structure for a plant in a pot that is connected to, and extends upwardly, from the pot.

The support structure comprises: (a) at least one pillar that is connected to the pot; and (b) a mesh supported by and connected to the pillar, whereby the plant grows upwardly through, and is supported by, the mesh.

The present invention further provides a plant pot and support structure comprising: (a) a plant pot; (b) at least one pillar secured to the plant pot and extending upwardly therefrom; and (c) at least one mesh supported by and connected to the pillar.

The plant pot can have a sidewall that includes a bore for receiving an end of the pillar, one respective bore being provided to receive each provided pillar.

The plant pot and support system can include at least three pillars in which the mesh is connected to and supported by each pillar.

The mesh can comprise a grid, webbing, netting, a screen, a lattice, or any other suitable type of reticulated grid structure. The mesh can comprise any suitable type of material, including metal, wood, polymer materials, textiles (e.g., string), or combinations or composites thereof.

The plant pot and support structure can include a second mesh, wherein the first and second meshes are positioned at a different elevation (or distance) from the each other and from the plant pot.

The plant pot and support structure can further include at least one extension pillar that is connected to and extends upwardly from each pillar provided.

In another embodiment, the invention can comprise a plant pot having a sidewall that includes at least one bore, or through-hole, for receiving an end of a pillar, one respective bore being provided to receive each provided pillar.

For a more complete understanding of the present invention, reference is made to the following detailed description and accompanying drawings. In the drawings, like reference characters refer to like parts throughout the views in which:

### BRIEF DESCRIPTION OF THE DRAWINGS

FIG. 1 is a perspective view of a first embodiment of the present invention hereof;

FIG. 2 is a perspective view of a plant pot showing bores for receiving the pillars;

FIG. 3 is an enlarged partial view showing one embodiment for securing a pillar to an extension pillar;

FIG. 4 is a perspective view of the plant pot and support structure showing an optional second mesh secured to a plurality of extension pillars; and

FIG. 5 is a perspective view of an alternate embodiment of the invention showing the plant pot having a sidewall that includes at least one bore, or through-hole.

### DETAILED DESCRIPTION OF THE PREFERRED EMBODIMENT

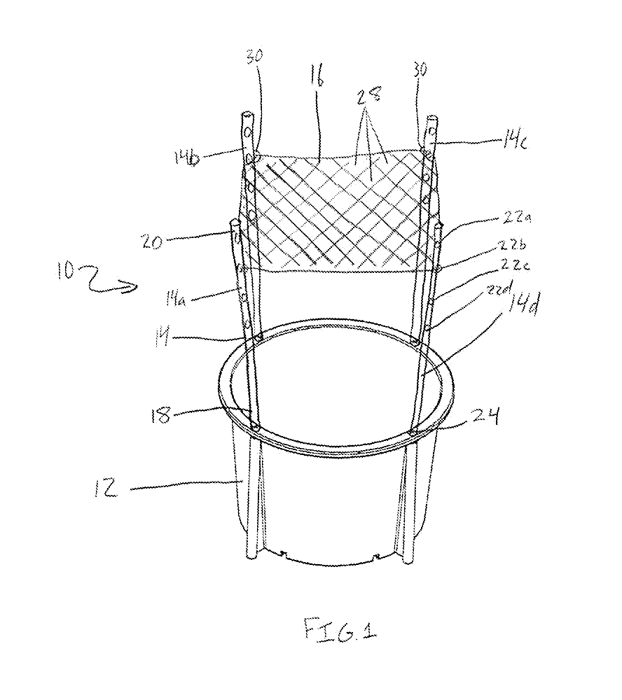

In accordance with the present invention, and as shown generally in FIG. 1, there is provided a support structure 10 for a plant (not shown) in a pot 12 that is connected to, and extends upwardly, from the pot 12. As described in further detail below, the support structure 10 is connected to and supported by the pot 12.

The support structure 10 comprises: (a) at least one pillar 14 that is connected to the pot 12; and (b) a mesh 16 supported by and connected to the pillar 14, whereby the plant grows upwardly through, and is supported by, the mesh 16. The pot 12 can comprise any suitable type of material which is well-known in the art, including terra cotta, plastic, or the like. Preferably, the pot 12 comprises a plastic polymer material so that it can be easily manufactured, such as by injection molding.

The pillar 14 is an elongated stick-like strut, or column, that extends in a generally upward direction. The pillar 14 has a base end 18 and an extension end 20. The pillar 14 can comprise any suitable type of material, including metal, wood, polymer materials, reinforcement materials (e.g., glass, carbon fiber, etc.), or combinations or composites thereof. The plant pot 12 and support structure 10 can include at least three pillars 14a, 14b, 14c, in which the mesh 16 is connected to and supported by each pillar 14a, 14b, 14c. Optionally, the pillar 14 can include a plurality of holes 22a, 22b, etc. to assist in attaching the mesh 16.

The support structure 10 can be used with only one pillar 14, so long as adequate means are provided for supporting the mesh 16, such as providing a mesh 16 frame (not shown) to encircle and support the perimeter of the mesh 16 and to connect to the pillar 14. Preferably, the support structure 10 includes at least three pillars 14a, 14b, 14c. And even more preferably, the support system includes four pillars 14a, 14b, 14c, 14d. As described in further detail below, when three or more pillars 14 are provided, the mesh 16 does not require a mesh frame, and the mesh 16 can be secured directly to each pillar 14.

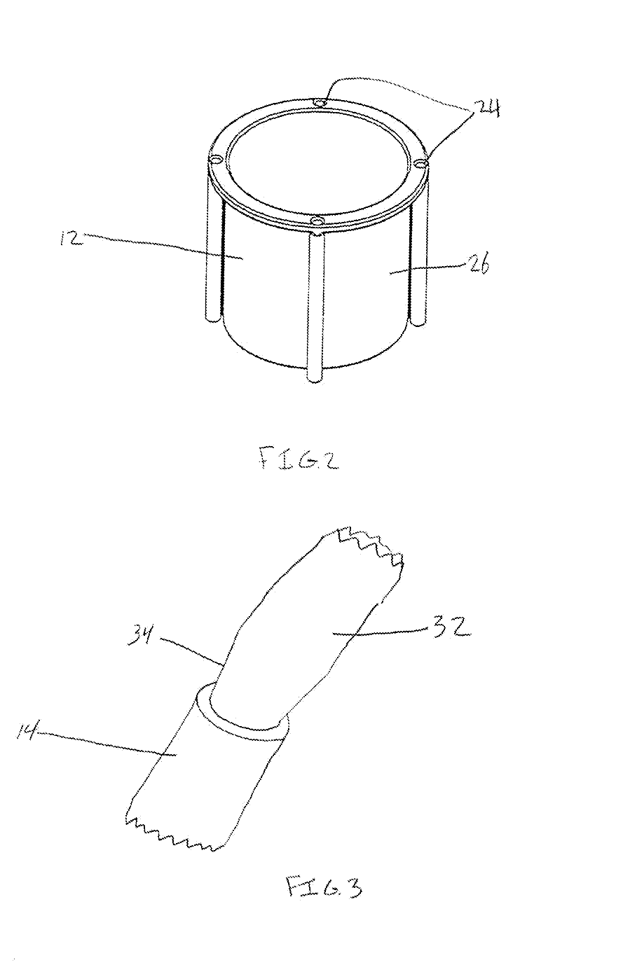

Means for securing 24 the base end 18 of the pillar 14 to the pot 12 are also provided. The means for securing 24 can include any suitable type of structure or device that is well-known in the art. For example, and as shown in FIG. 2, the means for securing 24 can include a bore, or elongated recess or hole, in a sidewall 26 of the pot 12 for receiving the base end 18 of the pillar 14. Alternatively, the means for securing 24 can also include connecting the base end 18 of the pillar 14 to the sidewall 26 of the pot 12 using an adhesive or a mechanical fastener, such as screwing the base end 18 to the sidewall 26, using at least one ring clamp, or the like. The pillar 14 can also be integrally formed with the pot 12, such as being one unitary plastic piece. More permanent means for securing 24 can also be used when the materials are appropriate, such as welding or soldering. The invention is intended to cover any type of structure for securing the base end 18 of the pillar 14 to the sidewall 26 of the pot 12 that is well-known in the art and suitable for use herewith.

The mesh 16 can comprise a grid, webbing, netting, a screen, a lattice, or any other suitable type of reticulated grid structure. The mesh 16 can be rigid or flexible, depending upon the material forming the mesh 16. It can include openings 28 that are as small or as large as needed for each particular application. For instance, some plants may require large openings 28 to accommodate for large stalks, while other plants might benefit more from a finer mesh 16 having smaller openings 28. Preferably, the openings 28 are about 1″ to about 4″ wide. The mesh 16 can comprise any suitable type of material, including metal, wood, polymer materials, textiles (e.g., string), or combinations or composites thereof.

There are also means for attaching 30 the mesh 16 to the pillar 14. Any suitable type of means that is well-known in the art can be used. For example, twist-ties can be inserted through one of the holes 22a, 22b, 22c, 22d in the pillar 14 and then secured to the mesh 16. Any other suitable type of fastener can also be used, including string, zip-ties, and so forth. The pillar 14 can also optionally include a plurality of hooks (not shown) along its length for engaging the mesh 16.

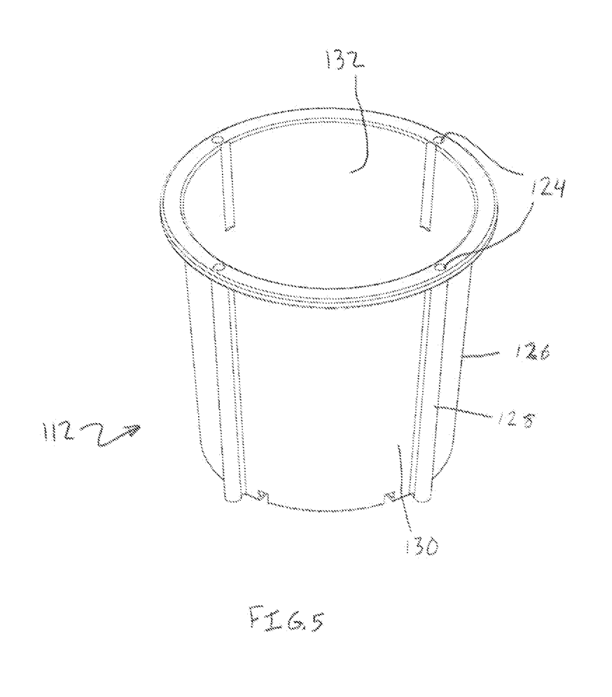

Optionally, and as shown in FIG. 4, the support structure 10 can include a second mesh 16b, wherein the first mesh 16a and the second mesh 16b are positioned at different elevations (or distances) from the each other and from the plant pot 12. In this regard, the multiple meshes 16a, 16b can be used to support the plant at various heights. Also, further additional meshes (not shown) can be added ongoing as the plant continues to grow upward.

In order to accommodate continued vertical growth of the plant, the support structure 10 can optionally include at least one respective extension pillar 32 that is connected to and extends upwardly from each pillar 14 provided. The extension pillar 32 is connected to and extends upwardly from the extension end 20 of the pillar 14. The extension pillar 32 can be connected to the extension end 20 of the pillar 14 using any suitable means, including but not limited to, a mechanical fastener or an adhesive.

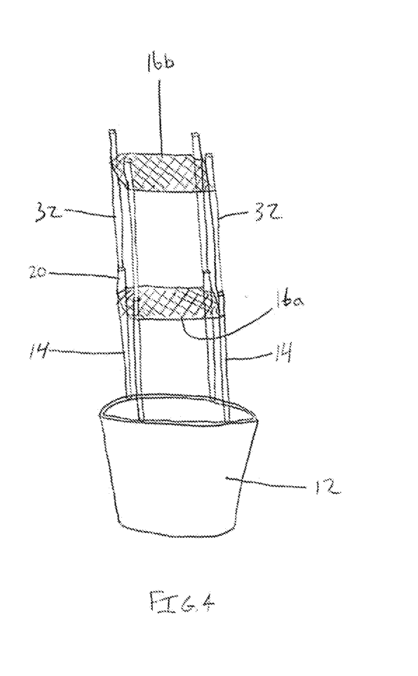

In addition, and as shown in FIG. 3, the extension end 20 of the pillar 14 and the extension pillar 32 can have complementary surfaces to permit interfitment with each other. For example, the extension end 20 of the pillar 14 can be hollow and have a circular cross-section, and the extension pillar 32 can have an outer cylindrical surface that is also circular. The outer diameter 34 of the extension pillar 32 can be approximately the same as the inner diameter of the extension end 20 of the pillar 14, thereby allowing the extension pillar 32 to be inserted into the extension end 20 of the pillar 14. Alternatively, the outer diameter 34 of the extension pillar 32 can be tapered, as shown. Thus, the pillar 14 and the extension pillar 32 can be quickly, easily, and securely attached to each other.

In addition, the pillars 14 and extension pillars 32 can either extend straight up from the pot 12 (as shown in FIGS. 1 and 4), or the pillars 14 and extension pillars 32 can flare, or extend, outwardly as they extend up from the pot 12. Preferably, the pillars 14 and extension pillars 32 can flare, or extend, outwardly from each other to accommodate plants that are wider at the top and narrower at the bottom. It is known that many plants grow outwardly as they grow taller. For instance, the bottom of the pot 12 might have a diameter of 11″, while the top of the top has a diameter of 13″. The pillars 14 and extension pillars 32 can extend upwardly and away from each other until they are about 23″ from each other.

Furthermore, although the pot 12 is shown as being generally cylindrical or conical in the drawings, it is to be understood that the pot 12 can be any suitable shape. For instance, it can have a square or rectangular cross-section at the top so that pots can be abutted against each other easily. The pot 12 can also be any suitable size, ranging from being only several inches wide at the top to having a volume of twenty gallons or more.

Optionally, cross-braces (not shown), or struts, can be connected between the pillars 14 to provide additional cross-strength as desired.

In another embodiment, and as shown in FIG. 5, the invention can comprise a plant pot 112 having a sidewall 126 that includes at least one bore 124, or through-hole.

The bore 124 can receive an end 18 of a pillar 14, one respective bore 124 being provided to receive each pillar 14. The sidewall 126 includes at least one substantially vertically-oriented member 128, or post, that is secured to the sidewall 126. The member 128 can be secured to the exterior side 130 of the sidewall 126, the interior side 132 of the sidewall 126, or positioned within the sidewall 126. Preferably, and as shown in the drawings, the member 128 is positioned to the exterior side 130 of the sidewall 126.

The bore 124 extends co-axially with the member 128, running downwardly through the member 128. Preferably, the bore 124 extends the entire length of the member 128, although optionally it can extend as little as one inch deep into the member 128. Although the bore 124 can have a consistent diameter along the entire length thereof, the bore 124 can optionally be tapered so that its diameter narrows downwardly along the length of the bore 124. In this regard, the bore 124 can receive pillars 14 of varying diameters and each pillar can be secured into a bore 124 by simply inserting the pillar 14 into the bore 124 until the pillar 14 is snugly and frictionally engaged into the bore 124. If necessary, the various pillars can be cut at the extension end 20 so that each extension end 20 extends the same distance above the plant pot 112.

According to the invention described above, a support structure for a plant is provided which provides adequate support to the plant because the support structure is connected to, and extends upwardly, from the pot rather than being staked into the soil in the pot. Furthermore, the support structure allows the plant and the pot to be repositioned or moved as desired.

What is claimed is:

1. A plant pot and support structure for supporting a plant growing in the plant pot comprising:
(a) the plant pot;
(b) at least one pillar connected to the plant pot; and
(c) at least one mesh supported by and connected to the pillar, whereby the plant grows upwardly through, and is supported by, the mesh.

2. The plant pot and support structure of claim 1 wherein the plant pot includes a sidewall that has at least one bore for receiving an end of the pillar.

3. The plant pot and support structure of claim 2 including at least three pillars and the mesh is connected to and supported by each pillar.

4. The plant pot and support structure of claim 3 wherein the mesh comprises a flexible material.

5. The plant pot and support structure of claim 4 having a second mesh, the second mesh being positioned at a different elevation from the plant pot than a first mesh.

6. The plant pot and support structure of claim 5 including at least one extension pillar that is connected to and extends upwardly from the pillar.

7. The plant pot and support structure of claim 3 having a second mesh, the second mesh being positioned at a different elevation from the plant pot than a first mesh.

8. The plant pot and support structure of claim 2 wherein the mesh comprises a flexible material.

9. The plant pot and support structure of claim 8 having a second mesh, the second mesh being positioned at a different elevation from the plant pot than a first mesh.

10. The plant pot and support structure of claim 1 including at least three pillars and the mesh is connected to and supported by each pillar.

11. The plant pot and support structure of claim 10 having a second mesh, the second mesh being positioned at a different elevation from the plant pot than a first mesh.

12. The plant pot and support structure of claim 11 including at least one extension pillar that is connected to and extends upwardly from the pillar.

13. The plant pot and support structure of claim 1 wherein the mesh comprises a flexible material.

14. The plant pot and support structure of claim 13 having a second mesh, the second mesh being positioned at a different elevation from the plant pot than a first mesh.

15. The plant pot and support structure of claim 1 having a second mesh, the second mesh being positioned at a different elevation from the plant pot than a first mesh.

16. The plant pot and support structure of claim 15 including at least one extension pillar that is connected to and extends upwardly from the pillar.

17. A plant pot having a sidewall that includes at least one bore extending downwardly along the sidewall.

18. The plant pot of claim 17 including at least one substantially vertically-oriented member that is secured to the sidewall, the bore extending downwardly through the member.

19. The plant pot of claim 17 wherein the member is secured to an exterior side of the sidewall.

20. The plant pot of claim 17 wherein the bore is tapered, having a diameter that decreases as the bore extends downwardly along the sidewall.
